(19) United States
(12) Patent Application Publication
(10) Pub. No.: US 2014/0380341 A1
(43) Pub. Date: Dec. 25, 2014

(54) APPLICATION ACTIVATION USING DECOUPLED VERSIONING

(71) Applicant: Microsoft Corporation, Redmond, WA (US)

(72) Inventors: Matt Geimer, Redmond, WA (US); Yi Jin, Redmond, WA (US); Mark Brewster, Seattle, WA (US); Hailei Zhang, Redmond, WA (US); Sylvain Dechatre, Redmond, WA (US); Shawn McDowell, Redmond, WA (US)

(21) Appl. No.: 13/923,225

(22) Filed: Jun. 20, 2013

(51) Int. Cl. G06F 9/54

(52) U.S. Cl. CPC G06F 9/54
USPC 719/328

(57) ABSTRACT

Instead of an application specifying that it uses an entire API, the application specifies the subset(s) of the API that it uses. Specific hosts can choose when to implement a subset of the API set without having to support other subsets of the API. When the host implements a subset of API set that was not previously supported, an application that specified the use of the newly supported subset begins to work on the hosts automatically. An application may specify subsets having different versions. For example, the versions of different subsets that are specified may be different. When the host supports the subsets used by the application, the application is activated (i.e. “run”). When the host does not support one or more of the subsets used by the application, the application is not activated.

### BACKGROUND

Application Programming Interfaces (APIs) are often used by developers when creating an application. Over time, these APIs are updated to include new functionality or delete functionality. Generally, updates to the API are compatible with older versions of the API. At some point in time, however, older versions of the API are no longer supported. Each version of the API includes a unique name or number. For example, initially a version of the API may be 1.0, and each subsequent version increments the number (e.g. 1.1, 1.2, 2.0, . . . ). Different devices may support different APIs. For example, an older device may support up to version 1.2 whereas a newer more powerful computing device may support version 2.2. An application developed for one platform may fail when the application is attempted to be run on another platform. For example, the application may attempt to call an API method that is not supported by the device's API version.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Applications specify one or more subsets of an Application Programming Interface (API) that they use. Instead of an application specifying that it uses the entire API, the application specifies the subset(s) that it uses. The API is split into different subsets that each includes a portion of the API. For example, an API may be split into different API subsets based on a functionality of each API method (e.g. binding APIs placed in one API subset and User Interface APIs placed in another API subset). A host (i.e. the underlying platform engaged with by an application through the API) may or may not support one or more subsets of the API that an application uses. Specific hosts can choose when to implement a subset of the API set without having to support other subsets of the API. When the host implements a subset of API set that was not previously supported, an application that specified the use of the newly supported subset begins to work on the hosts automatically. One or more subsets of the API may change as new versions of the subset of the API are released. An application may specify subsets having different versions. For example, the versions of different subsets that are specified may be different. The subsets of the API that are used by an application are determined when the application is loaded on a host. When the host supports the subsets used by the application, the application is activated (i.e. “run”). When the host does not support one or more of the subsets used by the application, the application is not activated.

### BRIEF DESCRIPTION OF THE DRAWINGS

FIG. 1 shows a system activating applications that specify API sets;

FIG. 2 shows different API subsets and hosts;

FIG. 3 shows example applications that specify subsets of an API interacting with other applications;

FIG. 4 illustrates determining when to activate an application based on specified subsets of an API;

FIG. 5 illustrates splitting an API into subsets and developing an application using one or more subsets;

FIG. 6 illustrates an exemplary online system activating applications based on specified subsets of an API; and

FIGS. 7, 8A, 8B and 9 and the associated descriptions provide a discussion of a variety of operating environments in which embodiments of the invention may be practiced.

### DETAILED DESCRIPTION

Referring now to the drawings, in which like numerals represent like elements, various embodiment will be described.

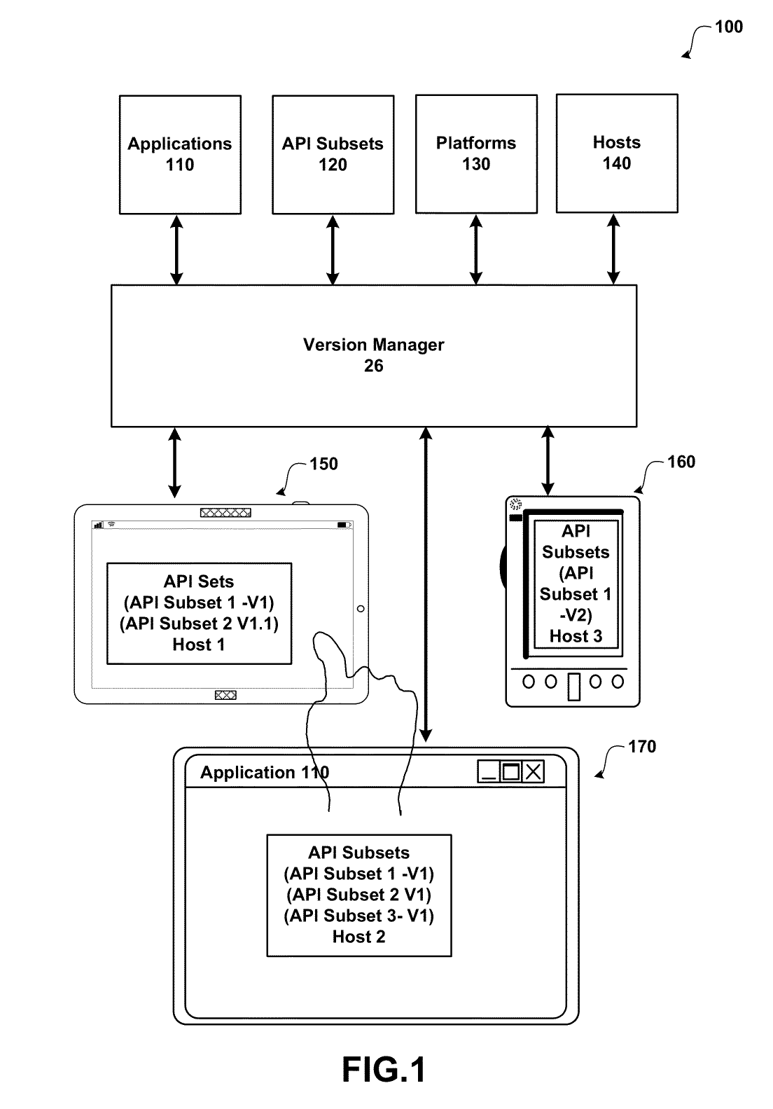

FIG. 1 shows a system activating applications that specify API sets.

As illustrated, system 100 includes applications 110, API subsets 120, platforms 130, hosts 140, version manager 26, tablet computing device 150, smart phone device 160, and computing device 170.

Version manager 26 is configured to determine when to activate an application. Applications, such as applications 110, specify one or more subsets of an Application Programming Interface (API) that they use. Instead of an application specifying that it uses an entire API, the application specifies the subset(s) that it uses.

API subsets 120 include the different subsets for one or more APIs. An API is split into different subsets that each includes a portion of the API methods for the API. An API may be split into different subsets based on a functionality of each API method. For example, binding API methods for an API placed in one API subset and User Interface API methods placed in another API subset. An API subset may include one or more API methods.

Hosts 140 include different hosts that use one or more subsets of an API. As used herein, the term “host” is a combination of an application that specifies one or more subsets and a platform. For example, one host may be an application that specifies version 1 of subset 1 of an API that runs on an ANDROID platform. Another host may be an application that specifies version 1 of subset 1, version 2 of subset 2 of an API that runs on the Internet. There are many different options. Each host may support one or more subsets of the API that an application uses. A host may be configured to run on a spectrum of clients ranging from a thin client (e.g. a browser) to a rich client, and the like. Specific hosts can choose when to implement a subset of the API set without having to support other subsets of the API. When the host implements a subset of API set that was not previously supported, an application that specified the use of the newly supported subset begins to work on the hosts automatically.

One or more subsets of the API may change as new versions of the subset of the API are released. An application may specify subsets having different versions. For example, the versions of different subsets that are specified may be different. The subsets of the API that are used by an application are determined when the application is loaded on a platform. When the host supports the subsets used by the application, the application is activated (i.e. “run”). When the host does not support one or more of the subsets used by the application, the application is not activated.

In order to facilitate communication with version manager 26, one or more callback routines, may be implemented. Applications 110 may be a variety of applications, such as business productivity applications, entertainment applications, music applications, travel applications, video applications, and the like. Generally, applications 110 may be any application that specifies API subsets. The applications 110 may be configured to receive different types of input (e.g. speech input, touch input, keyboard input (e.g. a physical keyboard and/or Software Input Panel (SIP)) and/or other types of input.

System 100 as illustrated comprises one or more touch screen input devices, such as tablet computing device 150 and smart phone device 160, that detects when a touch input has been received (e.g. a finger touching or nearly touching the touch screen). Any type of touch screen may be utilized that detects a user's touch input. More details are provided below.

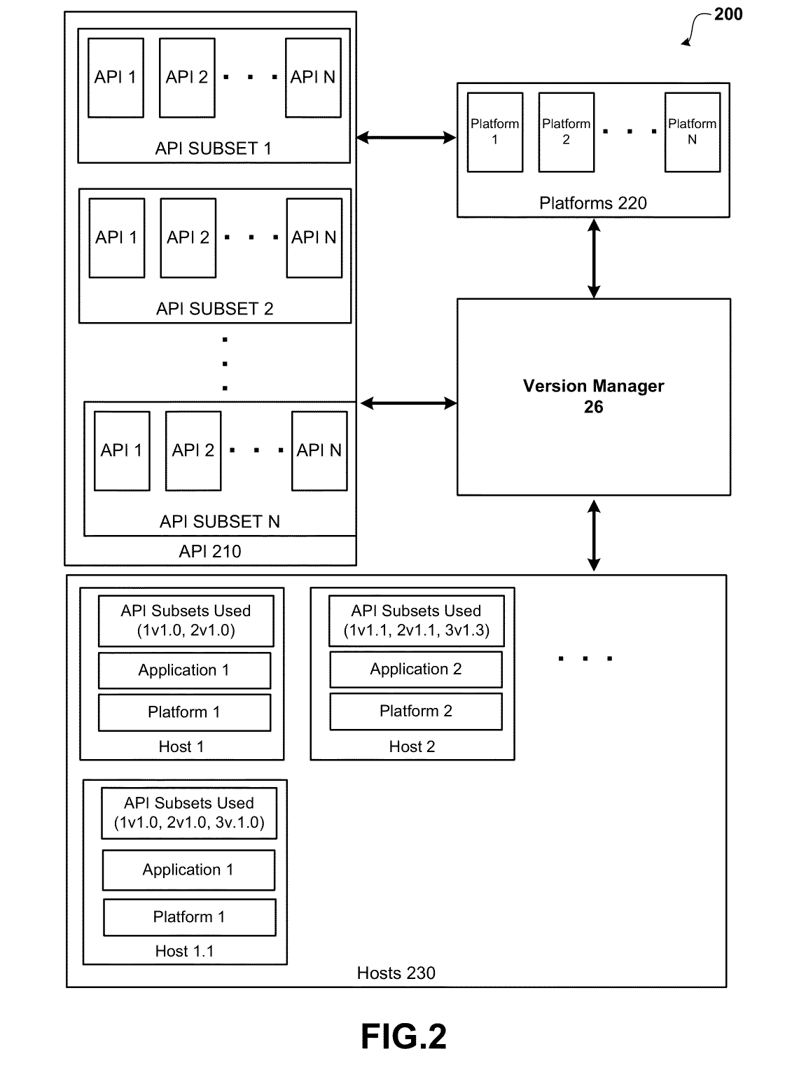

FIG. 2 shows different API subsets and hosts.

As illustrated, FIG. 2 shows system 200 including API 210, platforms 220, hosts 230 and version manager 26.

API 210 includes API subsets 1-N. Generally, an API may be split into two or more subsets. According to an embodiment, an API is split according to different functionality that is provided by the API. Generally, an API is split based on API methods that share a common functionality of the API. For example, an API may be split into subsets relating to user input, output, bindings, getting data, saving data, inputting data, output, navigation, file interactions, and the like. The following are example API sets, and are not intended to be limiting. Different API sets may include an API set for Navigation, Settings, Bindings, Selection, File, DocumentEvent, Binding Event, MatrixBinding, TableBinding, Selection, CustomXMLPart, File, DocumentEvent, BindingEvent, and the like. More than one API 210 may be split into subsets.

Platforms 220 show different platforms (e.g. Platform 1-N) that an application may be activated on. The platform may be a computing device running under a particular operating environment (e.g. MICROSOFT, APPLE, GOOGLE), an environment such as a thin client (e.g. a browser), a rich client, and the like.

Each developer has the flexibility to determine what subset or subsets of an API they would like to use. For example, one host (e.g. Host 1) may specify to use two subsets of an API whereas another host (e.g. Host 2) may specify three subsets of the API. A host may specify subsets that are of different versions. Some subsets may be at one version whereas other subsets may be a different version.

Different versioning schemes may be used to version an API and the subsets making up the API. For example, a major version number (e.g. “1”, “2”, . . . ) may be used along with a minor version number (e.g. “0.1”, “0.2”, . . . ) and the like. Generally, the major version number changes for a breaking change and the minor version changes for smaller changes. A change in the minor version number indicates that new API space has been added or a bug fix has occurred. According to an embodiment, backwards compatibility is maintained between minor version changes.

As discussed, each application specifies the API subsets that it uses. The application may specify the API subsets it uses and/or may specify the individual API methods that it uses. According to an embodiment, the application may specify a combination of API subsets and individual API methods. By using this model the developer can tightly target an application to a specific host family that provides supports for the specified API subsets. The application is activated when the specified subsets are supported. When the platform does not support a specified API subset or a specified API method, the application will not be activated.

According to an embodiment, the application may specify a minimum version of the API and/or a minimum version of a specified subset. For example, the following example, sets the minimum version of the subset “Bindings” and the minimum version of the subset of the subset including the getSelectedData API method to 1.1.

< minVersion=”1.1”>
<Subset=”Bindings” />
<API method= “getSelectedData” />

According to another embodiment, the application may override an individual named subset or and individual API minimum version with a different version. The following example shows where the developer specifies that the Navigation subset of the API minimum version of 1.7, with the other subsets set to a minimum version of 1.1.

< minVersion=”1.1”>
< minVersion=”1.7” Subset=”Navigation” />
<API method=”getSelectedData” /

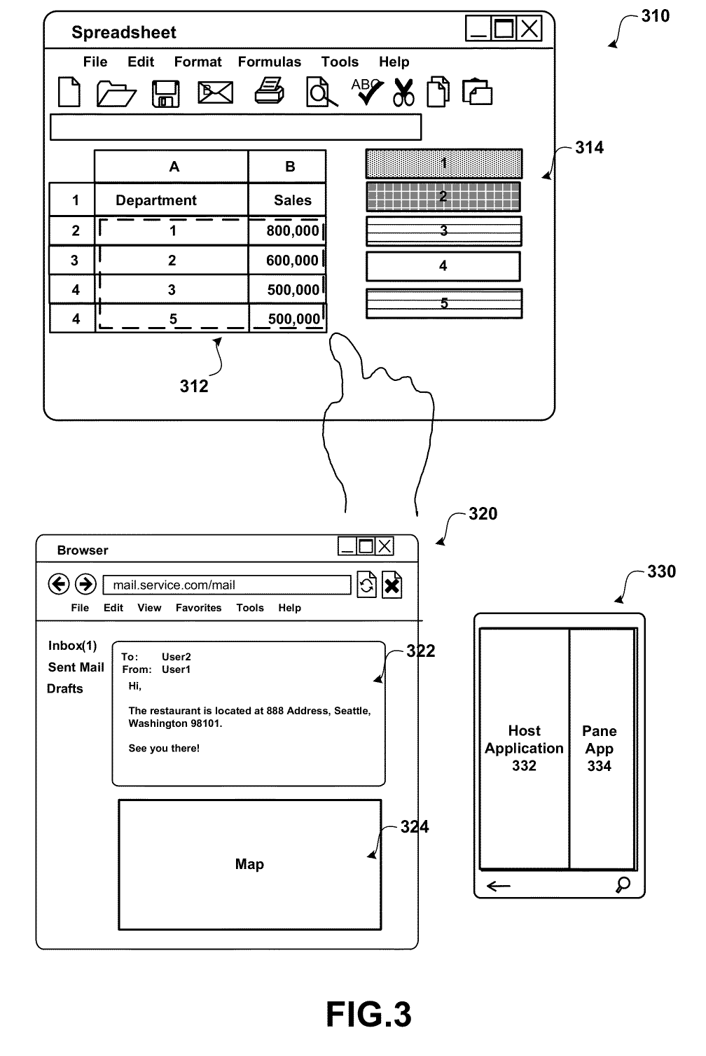

FIG. 3 shows example applications that specify subsets of an API interacting with other applications.

As illustrated, FIG. 3 shows display 310, display 320 and display 330.

The applications that specify the subsets of an API that is uses may be many different types of applications. The applications may be standalone applications that interact with a framework (e.g. MICROSOFT WINDOWS 8, APPLE IOS, GOOGLE ANDROID, . . . ) or applications that interact with other applications. According to an embodiment, the applications that specify the API subsets are applications that interact with productivity applications. For example, applications may be created to extend the functionality of a document application, electronic message application, and the like. An application may be developed to run in a single environment or a multiple environments and clients. An application developed for a rich client may specify a lot of different subsets of an API, whereas a thin client may specify just a few subsets of an API. In the examples illustrated in FIG. 3, the applications are hosted by another application (e.g. a productivity application).

Display 310 shows a spreadsheet application that includes a spreadsheet 312 and a charting application 314. Charting application 314 is an application that specifies one or more subsets of the API that is used to interact with spreadsheet 312. In the current example, charting application 314 updates a chart display of bars to show values that are selected in the spreadsheet 312. As can be seen bar 3 and bar 5 are filled using the same pattern to show the same color since they are the same value in spreadsheet 312.

Display 320 shows a message application being accessed through a browser application. In the current example, a map application 324 interacts with an electronic message application. Map application 324 may use one or more subsets that it specifies to use information that is within message 322. For example, map application 324 may automatically create a map of an address in the message.

Display 330 shows a host application 332 with a pane application 334. For example, pane application 334 may use one or more subsets of an API to interact with host application 332.

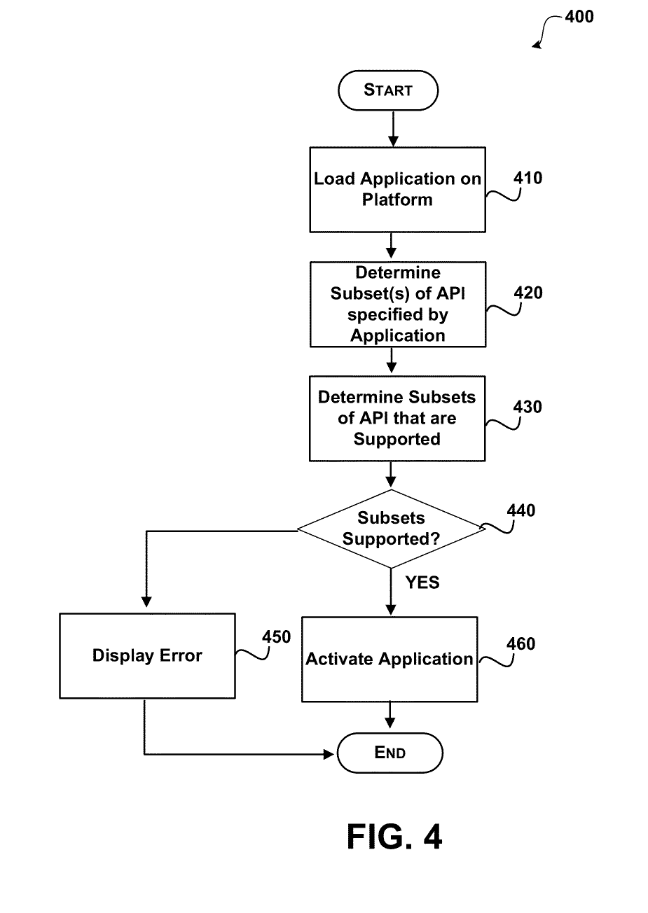

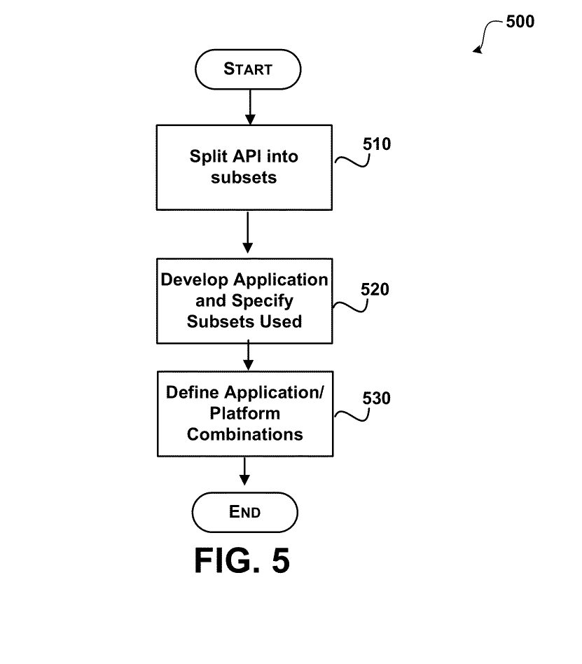

FIGS. 4 and 5 illustrate a process for application enablement using decoupled versioning. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

FIG. 4 illustrates determining when to activate an application based on specified subsets of an API.

After a start operation, the process moves to operation 410, where an application is loaded on a platform. The platform may be a computing device running under a particular operating environment (e.g. MICROSOFT, APPLE, GOOGLE), an environment such as a thin client (e.g. a browser), a rich client, and the like

Flowing to operation 420, the subsets of the APIs that are specified by the application are determined. The application may specify one or more subsets of an API using different methods. According to an embodiment, the subsets are specified in an application manifest. The subsets may be specified by identifying the subset or by identifying one or more of the API methods that are in a subset. The application may also specify different versions of the subsets that are used.

Transitioning to operation 430, the supported subsets of the API for the platform and host are determined. The host may support all or a portion of an API. Instead of a host needing to support an entire API, the host may support a portion of an API (e.g. one or more subsets of the API). The host may also support different versions of an API. A host may initially support a limited portion of the API and then later support more of the API.

Flowing to decision operation 440, a determination is made as to whether the specified subsets are supported. When the subsets are supported, the process flows to operation 460. When the subsets are not supported, the process flows to operation 450.

At operation 450, an error message is displayed when at least one of the specified subsets is not supported. Instead of the application being activated when functionality is not supported, the system does not activate the application when the functionality is not supported. A developer does not need to include programming code to stop the application from being activated when functionality is not supported by the platform (e.g. defensive programming). When the host implements a subset of API set that was not previously supported, an application that specified the use of the newly supported subset begins to work on the hosts automatically.

At operation 460, the application is activated when the specified subsets of the API are supported.

The process then flows to an end block and returns to processing other actions.

FIG. 5 illustrates splitting an API into subsets and developing an application using one or more subsets.

After a start operation, the process moves to operation 510, where an API is split into different subsets. Each API subset includes one or more individual API methods that are included in the API. According to an embodiment, the API is split into subsets based on the functionality of each individual API method. For example, API methods relating to bindings are placed into a subset, API methods relating to touch input are placed into another subset, API methods relating to file access are placed into another subset, and the like.

Flowing to operation 520, an application is developed using one or more of the API subsets. Instead of specifying an entire API (e.g. GOOGLE ANDROID 2.2, APPLE iOS 6, WINDOWS PHONE 8, . . . ), the application specifies the subset(s) of the API that it uses. The application may specify the subsets using different methods. According to an embodiment, the APIs are specified in an application manifest and may include the API sets and/or the individual APIs that it uses.

Transitioning to operation 530, the application may specify the different platforms that they would like to be activated on. For example, an application may specify to run on a rich client, a thin client, a web browser, an APPLE device, an ANDROID device, a MICROSOFT device, and the like.

The process then flows to an end block and returns to processing other action.

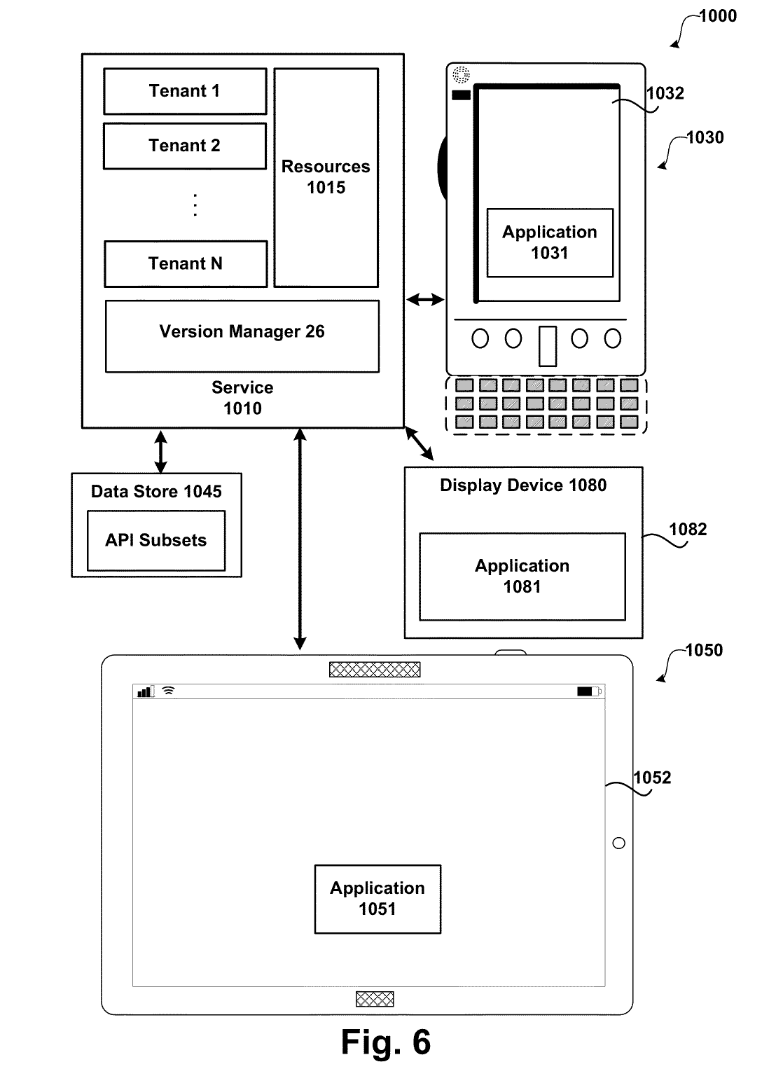

FIG. 6 illustrates an exemplary online system activating applications based on specified subsets of an API. As illustrated, system 1000 includes service 1010, data store 1045, touch screen input device 1050 (e.g. a slate), smart phone 1030 and display device 1080.

As illustrated, service 1010 is a cloud based and/or enterprise based service that may be configured to provide services, such as API versioning as described herein. The service may be interacted with using different types of input/output. For example, a user may use speech input, touch input, hardware based input, and the like. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 are configured with multimodal input/output and each include an application (1031, 1051, 1081) that specifies the subsets of an API that they use.

As illustrated, touch screen input device 1050, smart phone 1030, and display device 1080 shows exemplary displays 1052/1032/1082 showing the use of an application. Data may be stored on a device (e.g. smart phone 1030, touch screen input device 1050 and/or at some other location (e.g. network data store 1045). Data store 1045, or some other store, may be used to store API information, including subsets, as well as other data. The applications used by the devices may be client based applications, server based applications, cloud based applications and/or some combination. According to an embodiment, display device 1080 is a device such as a MICROSOFT XBOX coupled to a display.

Version manager 26 is configured to perform operations relating to application activation as described herein. While manager 26 is shown within service 1010, the functionality of the manager may be included in other locations (e.g. on smart phone 1030 and/or touch screen input device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

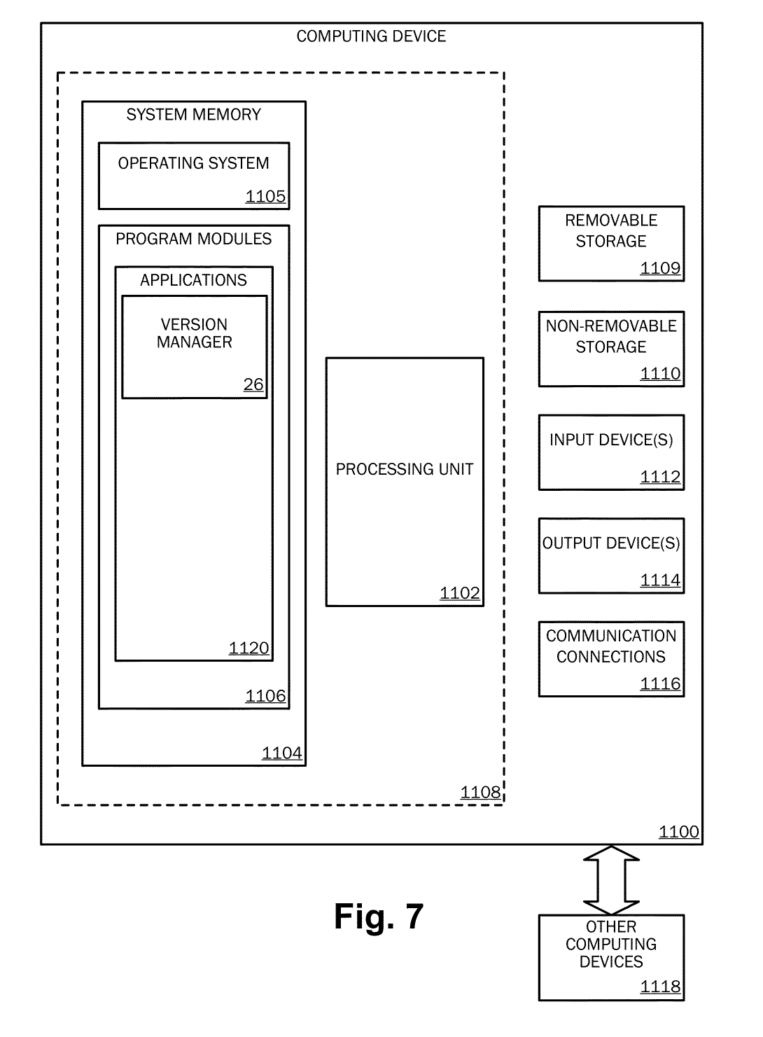

FIGS. 7-9 and the associated descriptions provide a discussion of a variety of operating environments in which embodiments of the invention may be practiced. However, the devices and systems illustrated and discussed with respect to FIGS. 7-9 are for purposes of example and illustration and are not limiting of a vast number of computing device configurations that may be utilized for practicing embodiments of the invention, described herein.

FIG. 7 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the version manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 7 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 7 by a removable storage device 1109 and a non-removable storage device 1110.

As stated above, a number of program modules and data files may be stored in the system memory 1104. While executing on the processing unit 1102, the program modules 1106 (e.g., the version manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the version manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

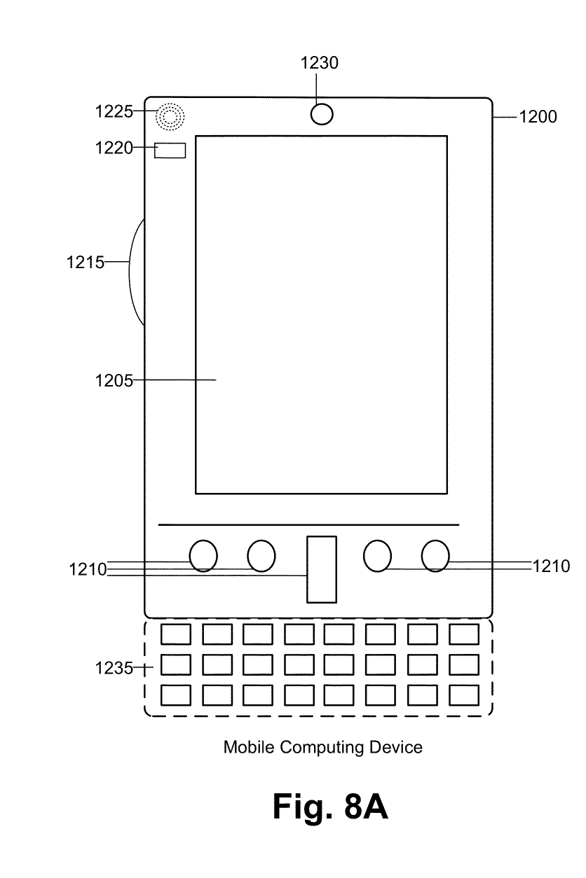

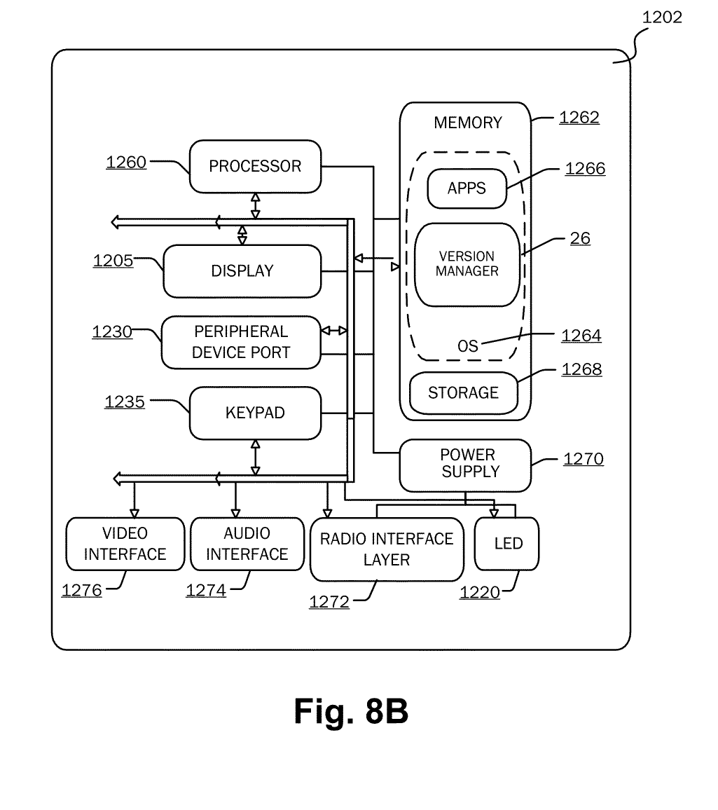

FIGS. 8A and 8B illustrate a mobile computing device 1200, for example, a mobile telephone, a smart phone, a tablet personal computer, a laptop computer, and the like, with which embodiments of the invention may be practiced. With reference to FIG. 8A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 1200 can incorporate a system 1202 (i.e., an architecture) to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the version manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 8B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

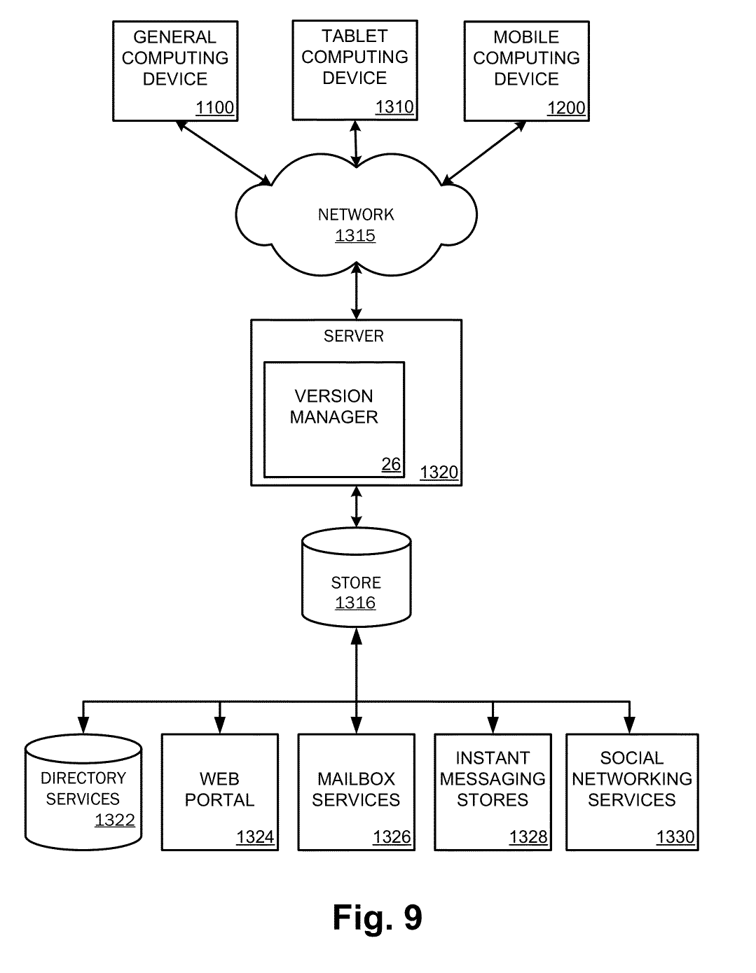

FIG. 9 illustrates an embodiment of an architecture of an exemplary system, as described above. Content developed, interacted with, or edited in association with the version manager 26 may be stored in different communication channels or other storage types. For example, various documents may be stored using a directory service 1322, a web portal 1324, a mailbox service 1326, an instant messaging store 1328, or a social networking site 1330. The version manager 26 may use any of these types of systems or the like for enabling data utilization, as described herein. A server 1320 may provide the version manager 26 to clients. As one example, the server 1320 may be a web server providing the version manager 26 over the web. The server 1320 may provide the version manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, and 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for application activation using decoupled versioning, comprising:
loading an application on a computing device;
determining a subset of an Application Programming Interface (API) that is specified by the application;
determining when a host supports the specified subset of the API; and
activating the application when the host supports the specified subset of the API.

2. The method of claim 1, wherein determining the subset of the Application Programming Interface (API) that is specified by the application comprises determining the specified subset based on an API method that is specified by the application and is part of the subset of the API.

3. The method of claim 1, wherein determining the subset of the Application Programming Interface (API) comprises determining a version for the specified subset of the API.

4. The method of claim 1, wherein determining when the host supports the specified subset of the API comprises determining when the host supports the specified subset of the API without checking that the host supports other subsets of the API.

5. The method of claim 1, wherein determining the subset of the Application Programming Interface (API) that is specified by the application comprises checking an application manifest associated with the application that specifies one or more subsets of the API.

6. The method of claim 1, further comprising determining a version for each specified subset of the API, wherein each specified subset of the API can be a different version.

7. The method of claim 1, wherein the API is split into subsets based on a common functionality.

8. The method of claim 1, further comprising displaying an error message when the host does not support the specified subset of the API.

9. The method of claim 1, wherein determining when the host supports the specified subset of the API comprises determining when a version of the subset of the API is supported by a computing platform.

10. A computer-readable medium storing computer-executable instructions for application activation using decoupled versioning, comprising:
loading an application on a computing device;
determining subsets of an Application Programming Interface (API) that are specified by the application in an application manifest;
determining when a host supports the specified subsets of the API;
activating the application when the host supports the specified subsets of the API; and
presenting an error when the host does not support the specified subsets of the API.

11. The computer-readable medium of claim 10, wherein determining the subsets of the Application Programming Interface (API) that are specified by the application comprises determining the specified subsets based on API methods that are specified by the application and are part of the subsets of the API.

12. The computer-readable medium of claim 10, further comprising determining a version for each of the specified subsets of the API.

13. The computer-readable medium of claim 10, wherein determining when the host supports the specified subsets of the API comprises determining when the host supports the specified subsets of the API without checking that the host supports other subsets of the API.

14. The computer-readable medium of claim 10, wherein the host can support a first portion of the API without supporting a second portion of the API.

15. The computer-readable medium of claim 10, wherein the API is split into subsets based on a common functionality of individual API methods.

16. The computer-readable medium of claim 10, wherein determining when the host supports the specified subsets of the API comprises determining when a version of each of the specified subsets of the API is supported by a computing platform.

17. A system for application activation using decoupled versioning, comprising:
a processor and memory;
an operating environment executing using the processor; and
a version manager that is configured to perform actions comprising:
loading an application;
determining subsets of an Application Programming Interface (API) that are specified by the application in an application manifest;
determining when a host supports the specified subsets of the API;
activating the application when the host supports the specified subsets of the API.

18. The system of claim 17, wherein determining the subsets of the Application Programming Interface (API) that are specified by the application comprises determining the specified subsets based on API methods that are specified by the application and are part of the subsets of the API.

19. The system of claim 17, wherein determining when the host supports the specified subsets of the API comprises determining when the host supports the specified subsets of the API without checking that the host supports other subsets of the API.

20. The system of claim 17, wherein the host can support a first portion of the API without supporting a second portion of the API.
